(19) United States
(12) Patent Application Publication
(10) Pub. No.: US 2002/0181349 A1
(43) Pub. Date: Dec. 5, 2002

(54) Optical-system driving apparatus and optical-system driving method

(76) Inventor: You Yoshioka, Yokohama-shi (JP)

Correspondence Address: PILLSBURY WINTHROP, LLP, P.O. BOX 10500, MCLEAN, VA, 22102, US

(21) Appl. No.: 09/955,308

(22) Filed: Sep. 19, 2001

(30) Foreign Application Priority Data
Jun. 1, 2001 (JP) 2001-167039

(51) Int. Cl. G11B 7/095

(52) U.S. Cl. 369/44.32; 369/44.35

(57) ABSTRACT

An optical-system driving apparatus of the present invention comprises a plurality of positioning means for positioning a spot of a light beam in an information recording position on an optical disk, sensing means for sensing the reflected light from the optical disk, a plurality of driving signal generating means for generating a plurality of driving signals for driving the plurality of positioning means respectively on the basis of the result of sensing the reflected light, converting means for converting the plurality of driving signals into a single multiple signal, decoding means for decoding the multiple signal into a plurality of signals, and driving means for driving the plurality of positioning means independently on the basis of the plurality of decoded signals.

### CROSS-REFERENCE TO RELATED APPLICATIONS

This application is based upon and claims the benefit of priority from the prior Japanese Patent Application No. 2001-167039, filed Jun. 1, 2001, the entire contents of which are incorporated herein by reference.

### BACKGROUND OF THE INVENTION

1. Field of the Invention

This invention relates to an optical-system driving apparatus and an optical-system driving method in an optical disk apparatus.

2. Description of the Related Art

In the servo control system of an optical disk apparatus, there are many channels that have to be controlled by power amplifiers, including a focus servo, a tracking servo, a sled servo, a tilt servo, aberration adjustment, and a spindle servo.

When circuits are integrated, they are considered to be ultimately squeezed into a single chip. Circuits difficult to squeeze into one chip because of structure are a preamplifier circuit, a digital signal processing circuit, and the decoding circuit of a power amplifier. As a result, an IC is prepared for each of these circuits. Between the ICs, signal pins for exchanging a lot of signals are provided.

Since there have been demands toward making optical disk apparatuses more compact, IC packages must be made smaller. ICs, however, require wiring on the wiring board, with the result that they need the IC package size proportional to the number of their input/output signal pins. This causes a problem: the size of ICs cannot be made smaller because of the number of signal pins, regardless of whether the body of the IC is made more microscopic.

Furthermore, in recent years, PWM power drivers have been widely used for high-efficiency driving. In the case of the PWM method, however, separating only the final-stage power element from the digital signal processing circuit usually requires two signals lines for each driving channel. That is, in this approach, the number of terminals has to be twice the number of driving channels (or the number of control axes).

Jpn. Pat. Appln. KOKAI Publication 2-120671 has disclosed the technique for transmitting data in a display data processing apparatus. In the publication, however, the characteristics unique to an optical disk apparatus have not been considered at all. Therefore, the solution to the above problem disclosed in the publication is insufficient.

### BRIEF SUMMARY OF THE INVENTION

It is, accordingly, an object of the present invention to provide an optical-system driving apparatus and an optical-system driving method which are suitable for the miniaturization of an optical disk apparatus.

To achieve the foregoing object, an optical-system driving apparatus and an optical-system driving method according to the present invention are constructed as follows:

(1) An optical-system driving apparatus of the present invention comprises: a plurality of positioning means for positioning a spot of a light beam in an information recording position on an optical disk; sensing means for sensing the reflected light of the light beam projected onto the optical disk; a plurality of driving signal generating means for generating a plurality of driving signals to drive the plurality of positioning means respectively on the basis of the result of sensing the reflected light sensed by the sensing means; converting means for converting the plurality of driving signals generated by the plurality of driving signal generating means into a multiple digital signal for channels the number of which is smaller than the number of the positioning means; decoding means for receiving the multiple digital signal converted by the converting means and decoding it into a plurality of signals; and driving means for driving the plurality of positioning means independently on the basis of the plurality of signals decoded by the decoding means.

(2) An optical-system driving method of the present invention comprises: sensing the reflected light of a light beam projected onto an optical disk; generating a plurality of driving signals for driving a plurality of positioning means for positioning a spot of the light beam in an information recording position on the optical disk on the basis of the result of sensing the reflected light in the sensing step; converting the plurality of driving signals generated in the generating step into a multiple digital signal for channels the number of which is smaller than the number of the positioning means; receiving the multiple digital signal converted in the converting step and decoding it into a plurality of signals; and driving the plurality of positioning means independently on the basis of the plurality of signals decoded in the receiving step.

The information outputted from a digital servo signal processing circuit to a PWM modulation circuit is generally a discrete value of a finite word length mostly in discrete time control. Each of these signals is turned into a time-division multiple serial signal, thereby converting them into a single digital signal. A signal processing IC outputs the digital signal to a power driver IC. The power driver IC separates the serial data into values for the individual driving channels and inputs them to as many PWM modulators as the driving channels. With this configuration, the signal lines, which had to be about twice the number of driving channels in a conventional equivalent, can be reduced to one line. When the power driver is divided into sub-drivers, a serial signal may be provided separately for each of the respective systems.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 shows an example of an optical disk apparatus to which an optical-system driving apparatus and an optical-system driving method according to the present invention are applied;

FIG. 2 shows the data structure of a first example of a serial multiple digital signal generated by a multiplexer;

FIG. 3 shows the data structure of a second example of a serial multiple digital signal generated by the multiplexer; and

FIG. 4 is a flowchart to help explain the optical-system driving method according to the present invention.

### DETAILED DESCRIPTION OF THE INVENTION

Hereinafter, referring to the accompanying drawings, an embodiment of the present invention will be explained.

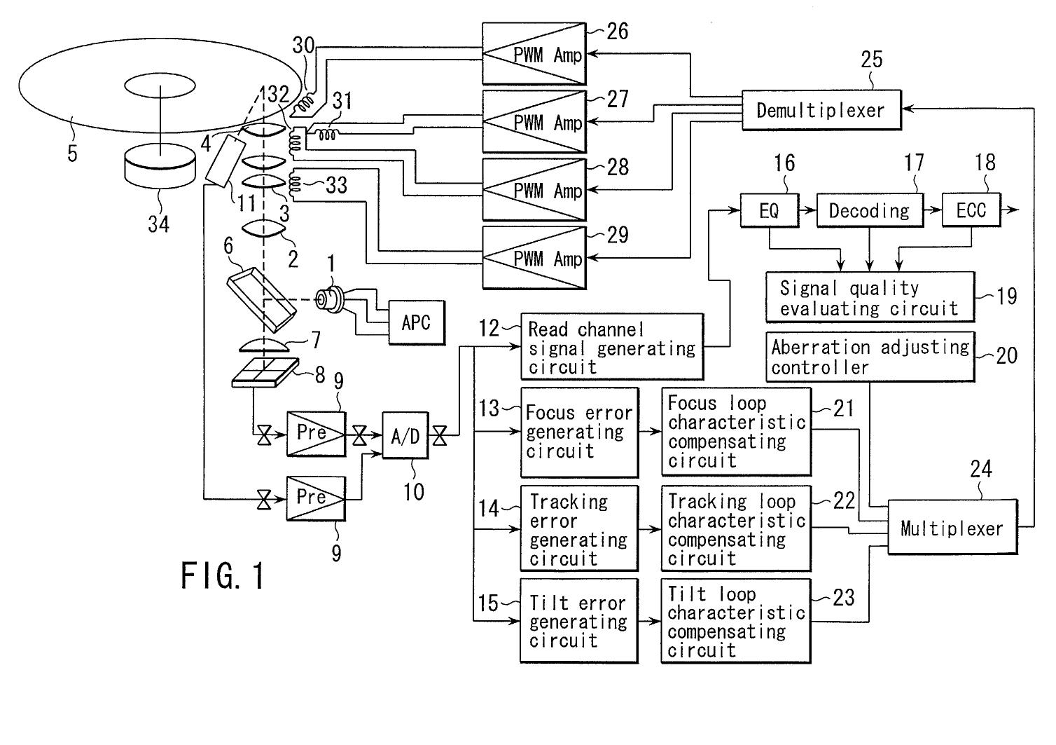

FIG. 1 shows an example of an optical disk apparatus to which an optical-system driving apparatus and an optical-system driving method according to the present invention are applied.

As shown in FIG. 1, the optical disk apparatus comprises a laser diode 1, a collimator lens 2, a relay lens group 3, an objective 4, a beam splitter 6, an astigmatism sensing lens 7, an optical detector 8, a preamplifier 9, an A/D converter 10, a tilt sensor 11, a read channel signal generating circuit 12, a focus error generating circuit 13, a tracking error generating circuit 14, a tilt error generating circuit 15, a waveform equalizing circuit (EQ) 16, a decoding circuit 17, an error correcting circuit (ECC) 18, a signal quality evaluating circuit 19, an aberration adjusting controller 20, a focus loop characteristic compensating circuit 21, a tracking loop characteristic compensating circuit 22, a tilt loop compensating circuit 23, a tilt multiplexer 24, a demultiplexer 25, PWN amplifiers 26, 27, 28, 29, a tilt actuator 30, a tracking actuator 31, a focus actuator 32, an aberration correcting actuator 33, and a spindle motor 34.

The light beam emitted from the laser diode 1 is converted by the collimator lens 2 into parallel light. The relay lens group 3 subjects the parallel light to aberration adjustment. The resulting light passes through the objective 4 and is projected onto an information recording position on the optical disk apparatus 5 in the form of a beam spot. The beam spot is reflected by the optical disk and enters the objective 4 again. Then, it goes back to the relay lens group 3 and collimator lens 2 and is reflected by the beam splitter 6. The astigmatism sensing lens 7 adds astigmatism for focus error sensing to the light from the optical disk reflected by the beam splitter 6 and projects the resulting signal onto the optical detector 8, which converts the signal into an analog electric signal.

The analog electric signal converted by the optical detector 8 is amplified in amplitude by the preamplifier 9. The amplified signal is inputted to the A/D converter 10, which converts it into a digital discrete-time discrete value signal. The output of the tilt sensor 11 for sensing the tilt of the objective 4 is also inputted to the preamplifier 9. The output of the preamplifier 9 is converted by the A/D converter 10 into a digital signal.

On the basis of the digital signal outputted from the A/D converter 10, the focus error generating circuit 13 generates a focus error signal. The focus loop characteristic compensating circuit 21 subjects the focus error signal to phase compensation and gain adjustment in order to stabilize the focus feedback loop. Thereafter, the focus error signal is inputted to the multiplexer 24. The multiplexer 24 multiplexes the focus error signal as a focus driving signal with other servo signals and sends the resulting signal through a single signal channel to the demultiplexer 25. The demultiplexer 25 separates the focus driving signal from the multiple signal and returns it to its original signal. The focus driving signal is inputted to the PWM amplifier 28. The power-converted signal is inputted to the focus actuator 32, which drives the objective 4 in the direction of focus. What has been explained above is about the focus servo system.

On the other hand, on the basis of the digital signal outputted from the A/D converter 10, the tracking error generating circuit 14 generates a tracking error signal. The tracking loop characteristic compensating circuit 22 subjects the tracking error signal to phase compensation and gain adjustment in order to stabilize the tracking feedback loop. Thereafter, the tracking error signal is inputted to the multiplexer 24. The multiplexer 24 multiplexes the tracking error signal as a tracking driving signal with other servo signals and sends the resulting signal through a single signal channel to the demultiplexer 25. The demultiplexer 25 separates the tracking driving signal from the multiple signal and returns it to its original signal. The tracking driving signal is inputted to the PWM amplifier 27. The power-converted signal is inputted to the tracking actuator 31, which drives the objective 4 in the direction of tracking. What has been described above is about the tracking servo system.

Furthermore, on the basis of the digital signal outputted from the A/D converter 10, the tilt error generating circuit 15 generates a tilt error signal. The tilt loop characteristic compensating circuit 23 subjects the tilt error signal to phase compensation and gain adjustment in order to stabilize the tilt feedback loop. Thereafter, the tilt error signal is inputted to the multiplexer 24. The multiplexer 24 multiplexes the tilt error signal as a tilt driving signal with other servo signals and sends the resulting signal through a single signal channel to the demultiplexer 25. The demultiplexer 25 separates the tilt driving signal from the multiple signal and returns it to its original signal. The tilt driving signal is inputted to the PWM amplifier 26. The power-converted signal is inputted to the tilt actuator 30, which drives the objective 4 in the direction of tilt. What has been explained above is about the tilt servo system.

In addition, on the basis of the digital signal outputted from the A/D converter 10, the read channel generating circuit 12 generates a stream for reading the recording signal data. The waveform equalizing circuit 16 compensates the generated stream for frequency response. The decoding circuit 17 decodes the modulated data. The error correcting circuit 18 senses errors in the symbols and corrects them. On the other hand, the signals outputted from the waveform equalizing circuit 16, decoding circuit 17, and error correcting circuit 18 are inputted to the signal quality evaluating circuit 19, which creates an index value representing the signal quality of the read channel. The index value is inputted to the aberration adjusting controller 20, which generates an aberration control signal (aberration correcting signal) for the operation of finding the best aberration point by the hill-climbing method. The aberration control signal outputted from the aberration adjusting controller 20 is inputted to the multiplexer 24. The multiplexer 24 multiplexes the aberration control signal with other servo signals and sends the resulting signal through a single signal channel to the demultiplexer 25. The demultiplexer 25 separates the aberration control signal from the multiple signal and returns it to its original signal. The aberration control signal is inputted to the PWM amplifier 29. The power-converted signal is inputted to the aberration correcting actuator 33 for the relay lens group 3. The actuator 33 moves the structure of the relay lens, thereby changing the aberration mode. What has been explained above is about the aberration control system.

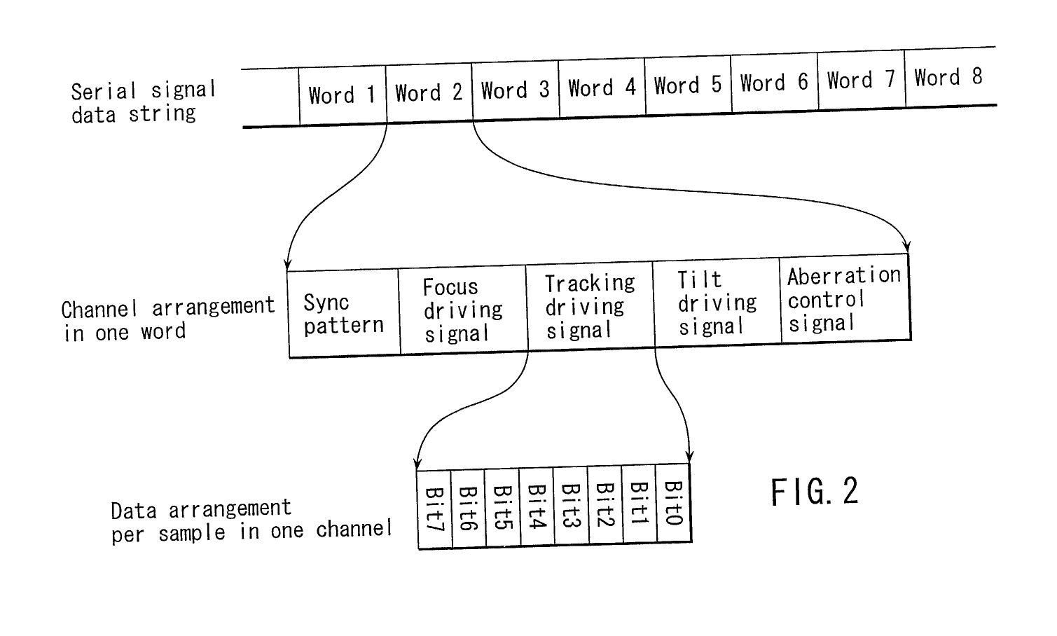

FIG. 2 shows the data structure of a first example of a serial multiple digital signal generated by the multiplexer 24.

Each driving channel supplies an 8-bit data code. The 8-bit data codes are subjected to bi-phase modulation, with the result that they are arranged sequentially from the MSB to LSB to form a data arrangement for one sample on one driving channel. The one-sample data arrangements for these driving channels are gathered. A sync pattern is added to the head of the gathered arrangements, thereby forming a one-word pack. That is, a one-word pack includes a sync pattern, a focus driving signal, a tracking driving signal, a tilt driving signal, and an aberration control signal. The sync pattern is necessary to sense the beginning of a word. What is obtained by arranging the words in sequence is a serial multiple digital signal generated by the multiplexer 24.

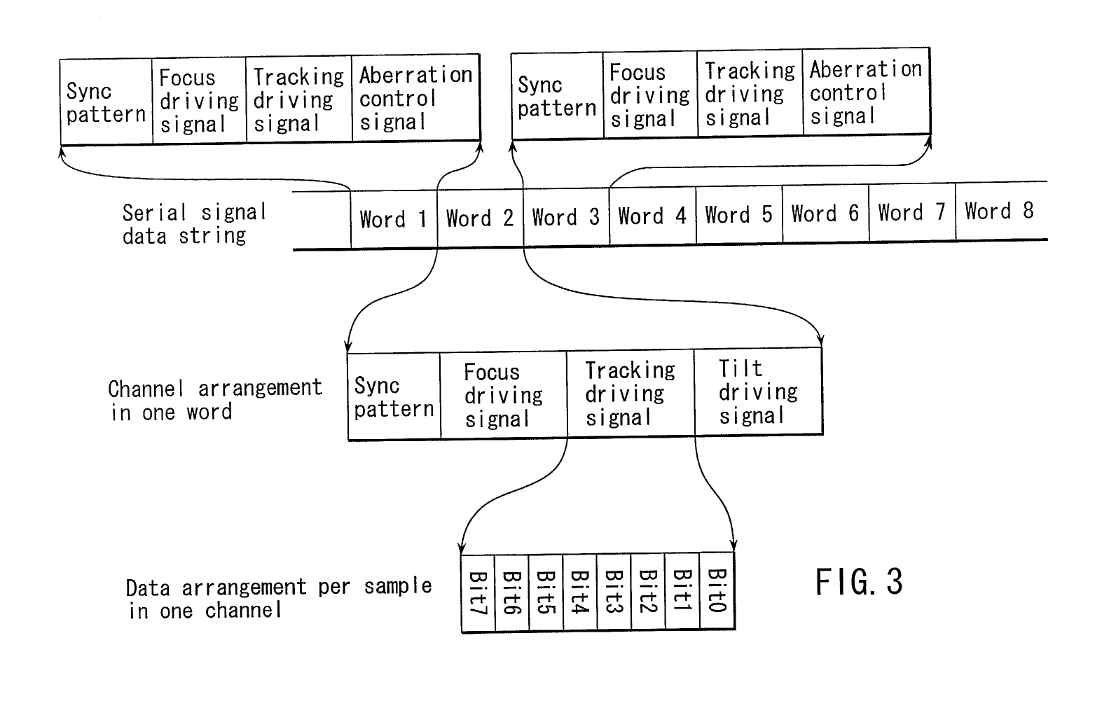

FIG. 3 shows the data structure of a second example of a serial multiple digital signal generated by the multiplexer 24.

The basic structure is the same as that of the serial multiple digital signal of FIG. 2, except for the frequency of supply of the tilt driving signal and aberration control signal. Depending on the purpose of use, the frequency of supply of the tilt driving signal and aberration control signal may be lower than that of the focus driving signal and tracking driving signal. Taking this into account, the data structure is made so as to time-divide the focus driving signal and tracking driving signal for each word and supply the resulting signals. That is, a word includes a sync pattern, a focus driving signal, a tracking driving signal, and a tilt driving signal. Another word includes a sync pattern, a focus driving signal, a tracking driving signal, and an aberration control signal. For example, an even-numbered word is caused to include a sync pattern, a focus driving signal, a tracking driving signal, and a tilt driving signal, and an odd-numbered word is caused to include a sync pattern, a focus driving signal, a tracking driving signal, and an aberration driving signal. This improves the frequency of supply of the focus driving signal and tracking driving signal.

In the explanation, the optical disk apparatus includes four actuators: the tilt actuator 30, tracking actuator 31, focus actuator 32, and aberration correcting actuator 33. The driving control of the four actuators has also been described. The present invention is not limited to these actuators.

For instance, the optical disk apparatus may include at least two of the tilt actuator 30, tracking actuator 31, focus actuator 32, and aberration correcting actuator 34 and perform driving control of these actuators. In the optical disk apparatus explained above, it is assumed that the demultiplexer 25, PWM amplifiers 26, 27, 28, 29 are squeezed into a single chip as one driving circuit.

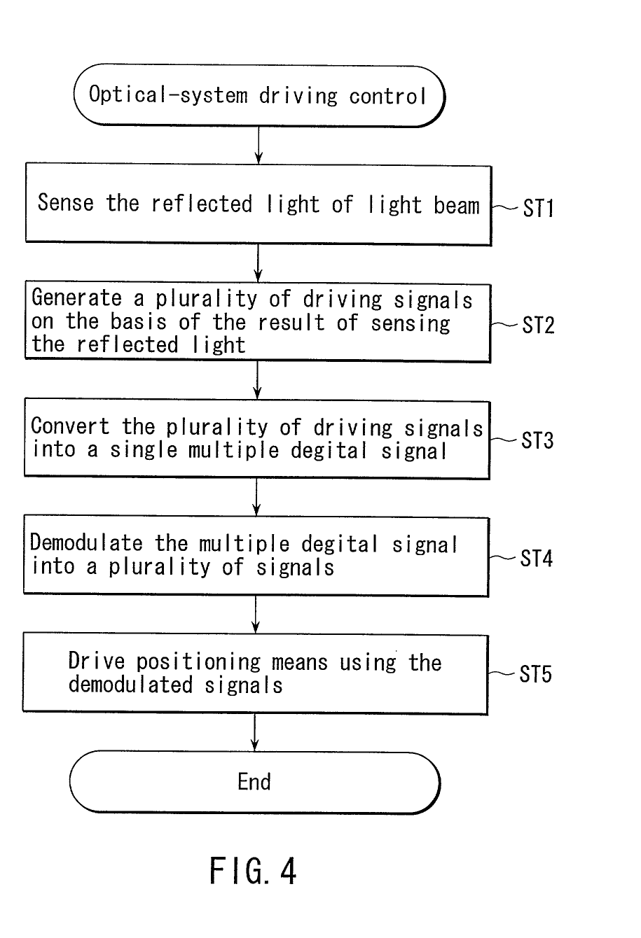

FIG. 4 is a flowchart to help explain the optical-system driving method according to the present invention.

First, the reflected light of the light beam projected onto the optical disk is sensed (ST1). On the basis of the result of sensing the reflected light, four driving signals for driving the tilt actuator 30, tracking actuator 31, focus actuator 32, and aberration correcting actuator 34 are generated (ST2). The tilt actuator 30, tracking actuator 31, focus actuator 32, and aberration correcting actuator 34 serve as positioning means for positioning the light beam spot in the information recording position on the optical disk. The four generated driving signals are converted into, for example, a one-channel multiple digital signal and then outputted (ST3). By converting the four driving signals into a multiple signal for channels the number of which is smaller than the number (=4) of the positioning means, the number of signal lines is decreased. The outputted multiple digital signal is received and decoded into a plurality of signals (ST4). On the basis of the plurality of decoded signals, the plurality of positioning means are driven independently (ST5).

As explained above, an n number of driving signals are converted into a multiple digital signal for channels the number of which is smaller than n and then outputted, resulting in a decrease in the number of signal lines. This makes it possible to make ICs smaller.

Additional advantages and modification will readily occur to those skilled in the art. Therefore, the invention in its broader aspects is not limited to the specific details and representative embodiments shown and described herein. Accordingly, various modifications may be made without departing the spirit or scope of the general inventive concept as defined by the appended claims and their equivalents.

What is claimed is:

1. An optical-system driving apparatus comprising:
a plurality of positioning means for positioning a spot of a light beam in an information recording position on an optical disk;
sensing means for sensing the reflected light of the light beam projected onto the optical disk;
a plurality of driving signal generating means for generating a plurality of driving signals to drive said plurality of positioning means respectively on the basis of the result of sensing the reflected light sensed by said sensing means;
converting means for converting the plurality of driving signals generated by said plurality of driving signal generating means into a multiple digital signal for channels the number of which is smaller than the number of said positioning means;
decoding means for receiving the multiple digital signal converted by said converting means and decoding it into a plurality of signals; and
driving means for driving said plurality of positioning means independently on the basis of the plurality of signals decoded by said decoding means.

2. The optical-system driving apparatus according to claim 1, wherein said plurality of positioning means include at least two of a tilt actuator, a tracking actuator, a focus actuator, and an aberration correcting actuator.

3. The optical-system driving apparatus according to claim 1, wherein said plurality of positioning means include a tracking actuator, a focus actuator, a tilt actuator, and an aberration correcting actuator,
said driving signal generating means generates a tracking error signal for driving said tracking actuator, a focus error signal for driving said focus actuator, a tile error signal for driving said tilt actuator, and an aberration correcting signal for driving said aberration correcting actuator, and
said converting means converts said tracking error signal, said focus error signal, said tilt error signal, and said aberration correcting signal into a serial multiple digital signal.

4. The optical-system driving apparatus according to claim 1, wherein said plurality of positioning means include a tracking actuator, a focus actuator, a tilt actuator, and an aberration correcting actuator,
said driving signal generating means generates a tracking error signal for driving said tracking actuator, a focus error signal for driving said focus actuator, a tile error signal for driving said tilt actuator, and an aberration correcting signal for driving said aberration correcting actuator, and
said converting means converts not only said tracking error signal, said focus error signal, and said tilt error signal but also said tracking error signal, said focus error signal, and said aberration correcting signal into a serial multiple digital signal.

5. A driving circuit applied to an optical disk apparatus which senses the reflected light of a light beam projected onto an optical disk, generates a plurality of driving signals on the basis of the result of the sensing, drives a plurality of positioning means on the basis of the plurality of driving signals, and thereby controls the positioning of a spot of the light beam in an information recording position on the optical disk, said driving circuit comprising:
decoding means for receiving and decoding a multiple digital signal for channels the number of which is smaller than the number of said plurality of positioning means; and
driving means for driving said plurality of positioning means on the basis of a plurality of signals decoded by said decoding means.

6. An optical-system driving method comprising:
sensing the reflected light of a light beam projected onto an optical disk;
generating a plurality of driving signals for driving a plurality of positioning means for positioning a spot of the light beam in an information recording position on the optical disk on the basis of the result of sensing the reflected light in said sensing step;
converting the plurality of driving signals generated in said generating step into a multiple digital signal for channels the number of which is smaller than the number of said positioning means;
receiving the multiple digital signal converted in said converting step and decoding it into a plurality of signals; and
driving said plurality of positioning means independently on the basis of the plurality of signals decoded in said receiving step.

7. The optical-system driving method according to claim 6, wherein said plurality of positioning means include a tracking actuator, a focus actuator, a tilt actuator, and an aberration correcting actuator,
said generating step generates a tracking error signal for driving said tracking actuator, a focus error signal for driving said focus actuator, a tile error signal for driving said tilt actuator, and an aberration correcting signal for driving said aberration correcting actuator, and
said converting step converts said tracking error signal, said focus error signal, said tilt error signal, and said aberration correcting signal into a serial multiple digital signal.

8. The optical-system driving method according to claim 6, wherein said plurality of positioning means include a tracking actuator, a focus actuator, a tilt actuator, and an aberration correcting actuator,
said generating step generates a tracking error signal for driving said tracking actuator, a focus error signal for driving said focus actuator, a tile error signal for driving said tilt actuator, and an aberration correcting signal for driving said aberration correcting actuator, and
said converting step converts not only said tracking error signal, said focus error signal, and said tilt error signal but also said tracking error signal, said focus error signal, and said aberration correcting signal into a serial multiple digital signal.
